(19) United States
(12) Patent Application Publication
(10) Pub. No.: US 2003/0203134 A1
(43) Pub. Date: Oct. 30, 2003

(54) Technique for modifying the coefficient of friction of ink jet media

(76) Inventor: Minghui Sheng, Cupertino, CA (US)

Correspondence Address: HEWLETT-PACKARD COMPANY, Intellectual Property Administration, P. O. Box 272400, Fort Collins, CO, 80527-2400, US

(21) Appl. No.: 10/431,487

(22) Filed: May 7, 2003

Related U.S. Application Data
(62) Division of application No. 09/383,884, filed on Aug. 26, 1999.

(51) Int. Cl. B32B 3/00

(52) U.S. Cl. 428/32.1

(57) ABSTRACT

Ink jet media having low coefficients of friction to enable efficient sheet feeding performance and which are compatible with modern inks. In a preferred embodiment, ink jet media include a substrate, a coating including a binder, a pigment, and a low friction substance. The low friction substance, in an emulsified form, is selected from the group consisting of waxes, simple organic polymers, silicone polymers and fluoropolymers. The binder is selected from the group consisting of polyvinylversatate, polyethelene, polyvinyl alcohol, polyvinylpyrrolidone and polyvinylacetate and it comprises between about 5% and about 30%, by weight, of the coating. Preferably, the pigment is alumina or silica. In addition, polyterfluoroethylene latex is utilized as a slip aid. A method of preparing ink jet media includes the steps of providing a substrate and a coating including a binder, as described above. The binder is mixed with a low friction substance, in an emulsified form, selected from the group consisting of waxes, simple organic polymers, silicone polymers and fluoropolymers. The mixture is applied to the substrate and the substrate is dried.

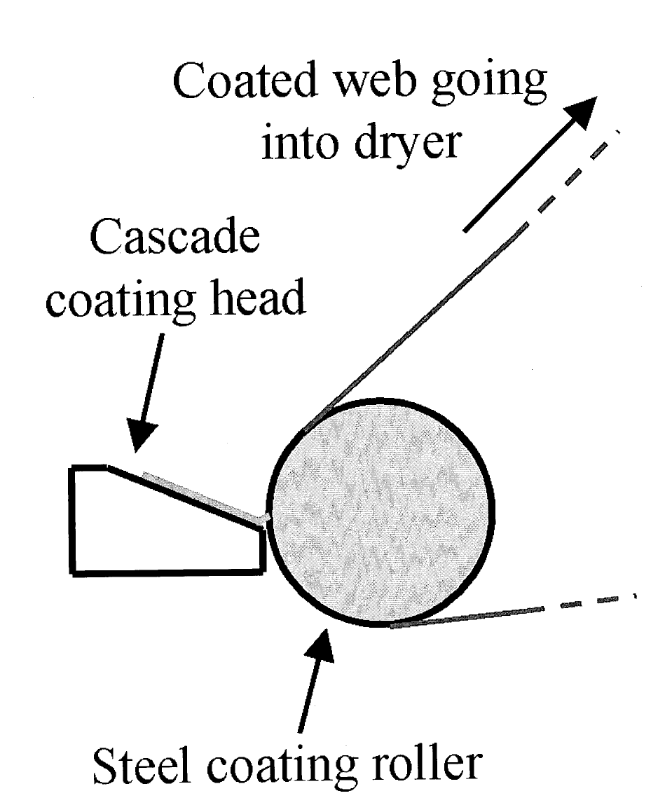

### BACKGROUND OF THE INVENTION

The present invention relates generally to ink jet media and, more particularly, to techniques for modifying the coefficient of friction of such media.

The need for coated paper is well established. Paper may be coated with polymeric or wax coatings for various reasons such as for imparting water resistance, increasing strength of paper stock, enhancing gloss and improving barrier qualities.

The selection of coatings for the paper media utilized in modern image transfer devices, including ink jet printers, presents several problems. For example, because of the necessity that such coatings be capable of absorbing water based inks, the coatings tend to be softened by water or humidity. As a result, when two of these coatings are in contact, interaction between soft polymer coatings tends to be high and some sticking results. This factor can present significant problems feeding a single sheet from a paper stack to a printer is desired. In addition, humidity in some cases can contribute to a tacky feeling in which is not aesthetically pleasing to the user and which can make the paper relatively difficult to handle.

Many of the pigments utilized in conventional ink jet coatings are characterized by high coefficients of friction. In fact, the silica and alumina pigments frequently utilized are referred to as “frictionizers”. Further, since it is often desirable that the media have a smooth texture and glossy consistency, the techniques utilized to achieve these characteristics often produce media having high coefficients of friction.

As mentioned, media having a high coefficient of friction can be troublesome in sheet feeding printer operations because of the tendency of one sheet to stick to another. The coefficient of friction problem becomes particularly troublesome when a glossy ink jet coating is desired on both sides of the media, in order to support two sided printing.

Some prior art solutions to the above described problems have been attempted. In U.S. Pat. No. 5,700,582, for example, backing materials are placed on a media substrate to reduce electrostatic charge and to reduce sheet to sheet friction and sticking. While this approach may have value in some cases, it is not suitable for media intended for two sided printing.

U.S. Pat. No. 5,474,843 discloses the use of polymeric beads sticking through the surface of the media coating to improve sheet feeding properties. This solution is not compatible with some modern paper production processes. For example, it is not acceptable in a coating doctoring process to have particulates catch on the doctoring apparatus with scratches thereby produced in the coating. Calendaring or other smoothing processes will also diminish the utility of this technique, as the polymeric beads tend to be pushed into the coating.

From the foregoing it is apparent that there is a need for glossy ink jet media coatings that are compatible with modern inks and that have a low coefficient of friction to enable efficient sheet feeding functions.

Desirably, as an additional benefit, such media coatings would have a non-tacky consistency for good handleability.

### SUMMARY OF THE INVENTION

According to the present invention, there are provided ink jet media having low coefficients of friction to enable efficient sheet feeding performance and which are compatible with modern inks. In a preferred embodiment, ink jet media include a substrate and a coating including a binder, a pigment, and a low friction substance. The low friction substance, in an emulsified form, is selected from the group consisting of waxes, simple organic polymers, silicone polymers and fluoropolymers. In a preferred embodiment, polyterfluoroethylene latex is utilized as a slip aid. The binder is selected from the group consisting of polyvinylversatate, polyethelene, polyvinyl alcohol, polyvinylpyrrolidone and polyvinylacetate and it comprises between about 5% and about 30%, by weight, of the coating. Preferably, the pigment is alumina or silica.

A method of preparing ink jet media of the present invention includes the steps of providing a substrate and a coating including a binder, as described above. The binder is mixed with a low friction substance, in an emulsified form, selected from the group consisting of waxes, simple organic polymers, silicone polymers and fluoropolymers. The mixture is applied to the substrate and the substrate is dried.

The present invention affords several advantages over conventional media coating techniques. For example, it utilizes low friction materials in an emulsified form to decrease the coefficient of friction of a two-sided ink jet coating. In general, low friction materials may be described as waxes, simple organic polymers, silicone polymers or fluorinated polymers. The use of these materials in an emulsified form allows easy incorporation into a water-based coating. This technique is novel and original since it is generally believed that these materials do not function at high concentrations in an ink jet coating because of their hydrophobic nature, which suggests poor wetting and adsorptivity of water based inks. In this regard, it has been discovered that the use of low-friction materials allows a decrease of sheet coefficient of friction without degrading image quality.

In addition, the examples set forth herein support the hypothesis that the preparation of the coating materials in emulsion form imparts desirable properties to the media when contacted with ink jet ink.

Other aspects and advantages of the present invention will become apparent from the following detailed description, illustrating by way of example the principles of the invention.

### BEST MODE FOR CARRYING OUT THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

A preferred embodiment of the present invention provides glossy ink jet media coatings that are compatible with modern inks and have a low coefficient of friction, to enable efficient sheet feeding functions. The inventive technique enables effective and efficient two-sided copying wherein both paper sides utilize glossy coatings having a low coefficient of friction. In this manner, improved ink retention is achieved while sheet-feeding problems are substantially reduced.

In a preferred embodiment, an ink jet media coating comprises a substrate including a binder and a low friction, in an emulsified form, selected from the group consisting of waxes, simple organic polymers, silicone polymers and fluoropolymers. Preferably, polyterfluoroethylene latex is utilized as a slip aid. The binder is selected from the group consisting of polyvinylversatate, polyethelene, polyvinyl alcohol, polyvinylpyrrolidone and polyvinylacetate and it comprises between about 5% and about 30%, by weight, of the coating.

A method of preparing ink jet media of the present invention includes the steps of providing a substrate and a binder as described above. The binder is mixed with a low friction substance, in an emulsified form, selected from the group consisting of waxes, simple organic polymers, silicone polymers and fluoropolymers. The mixture is applied to the substrate and the substrate is dried.

In the presently preferred embodiment, the slip aid is a dispersion in water and preferably, is polymeric. The particle size of the dispersion is less than 5 μm, or preferably, less than 1 μm. While a variety of functional groups are feasible, the preferred slip aid mainly includes the elements carbon, hydrogen, fluorine, silicon or the “oxo” form of oxygen for maintaining desired friction properties. These elements are found in waxes, simple organic polymers, silicone polymers and fluoridated polymers. In general, a number of latex dispersions may be classified as slip aids. Polyterfluoroethylene latex, available from E.I. duPont de Nemours and Co. under the trademark Zonyl® TE-3667N, and a high molecular weight polyethylene wax, available from Shamrock Technologies, Inc., Newark, N.J. under the designation Hydrocer-355, have proven effective. Other suitable slip aids are a nonionic polyethylene emulsion sold by Air Products and Chemicals, Inc., Allentown, Pa., as Vancryl® Wax 35 and a carnauba wax produced by Michelman, Inc., Cincinnati, Ohio, under the trademark MICHEM® LUBE 160.

According to the present invention, an ink jet coating is applied to a substrate by conventional methods. Typically, the coating includes pigment, binder and performance additives. A preferred pigment is psuedo-boehmite alumina, manufactured by Condea-Vista as Dispal 11N7-80. Its particle size in water is about 0.25 μm while dried particle size is about 50 μm.

In a preferred embodiment, the binders are polyvinylversatate polyethylene, present as a non-water soluble emulsion polymer, polyvinylalcohol and polyvinylpyrrolidone polyvinylacetate copolymer. The latter two are water soluble. These binders are present in dry solid weight percents of 2%, 0.6% and 11%, respectively. The polyvinylversatate polyethylene copolymer is manufactured by Mapei, Inc. of Canada, as Vinavil® 3525. The polyvinylalcohol is manufactured by Air Products and Chemicals, Inc., as Airvol® 165 and polyvinylpyrrolidone polyvinylacetate copolymer is available from Badische Anilin & Soda-Fabrik Aktiengesellschaft, Germany, under the trademark Luviskol®.

Performance additives are utilized for several reasons. For example, to control bleed and uniformity, diamine ethylene/propylene oxide surfactant, manufactured by BASF Corp. as Tetronic™ 701 and glycol, manufactured by Aldrich Chemical, are utilized. An organic acid, such as lactic acid manufactured by Aldrich, functions as a performance additive to control viscosity and bleeding. A silicon ether surfactant, manufactured by Air Products as Surfonyl™ D-58 serves as a performance additive to reduce foam. Finally, the performance additive polyterfluoroethylene latex, manufactured by E.I. DuPont de Nemours and Co. as Zonyl® TE-3667N, functions as a slip aid.

TABLE I sets forth the composition of a low cost, glossy ink jet coating, prepared according to the present invention and having a relatively low coefficient of friction.

TABLE I

| | General | | |
|---|---|---|---|
| Chemical | Class | Parts | Percent |
| Boehmite alumina | Pigment | 100 | 78.40063 |
| Polyvinylversatate | Binder | 14.4 | 11.28969 |
| Polyethylene copolymer | | | |
| Polyvinylalcohol | Binder | 0.8 | 0.627205 |
| Polyvinylpyrrolidone | Binder | 2.9 | 2.273618 |
| polyvinylacetate | | | |
| copolymer | | | |
| Diamine | Performance | 1.1 | 0.862407 |
| ethylene/propylene | additive | | |
| oxide surfactant | | | |
| Glycol | Performance | 1.3 | 1.019208 |
| | additive | | |
| Lactic acid | Performance | 1 | 0.784006 |
| | additive | | |
| Silicon ether | Performance | 0.05 | 0.0392 |
| surfactant | Additive | | |
| Polyterfluoroethylene | Slip aid | 6 | 4.7040938 |
| latex | | | |

In order to demonstrate the utility of the present invention, ink jet coatings formulated according to the present invention were tested. The examples that follow illustrate certain specific embodiments of the invention and describe comparative tests with commercially available ink jet media coatings.

### EXAMPLE 1

A coating was prepared that contained the substances set forth in TABLE I. The materials were mixed together and then coated on a clay-coated base sheet using a mayer rod. The sheet was dried for 5 minutes at 100° C. and then calendared until glossy. The constituents of the coating of Example I are set forth in TABLE II.

TABLE II

| | | | Parts (Dry |
|---|---|---|---|
| Chemical | Manufacturer | Grade | wgt.) |
| Pigment | Condea Vista | Dispal | 100 |
| | | 11N7-80 | |
| Polymer | ISP | PVPVA-7/30 | 3 |
| Polymer | Air Products and | Airvol ® 165 | 1 |
| | Chemicals, Inc. | | |
| Polymer | Vinavil | 3525 | 15 |
| Plastisizer | Aldrich Chemical | Glycerol Reagent | 2 |
| Surfactant | BASF Corp. | Tetronic ™ 701 | 1 |
| Surfactant | Air Products | Surfonyl DF-58 | 0.05 |
| Acid | Aldrich Chemical | Lactic Acid Reagent | 1 |
| Slip-aid | E.I DuPont de Nemours | Polyterfluoro | 6 |
| | & Co. | ethylene latex | |

### EXAMPLE 2

A second coating was prepared and a glossy sheet was produced by the method set forth in Example 1. The second coating was identical to the Example 1 coating except that 6 parts of Shamrock Hydrocer-355 (waxy polymer) were utilized as a slip aid instead of polyterfluoroethylene latex (Zonyl® TE-3667).

### EXAMPLE 3

A third coating was prepared and a glossy sheet was produced by the method set forth in Example 1. The coating utilized in this example is conventional. It is similar to the coatings of Examples 1 and 2 but differed therefrom by having neither the polyterfluoroethylene latex (Zonyl® TE-3667) of Example 1 nor the Shamrock Hydrocer-355 polyfluoroethylene polymer of Example 2.

Comparative tests were conducted on the coatings produced in the examples. The results are set forth in TABLE III.

TABLE III

| Results | Example 1 | Example 2 | Example 3 |
|---|---|---|---|
| 60 degree gloss | <40% | <40% | <40% |
| IQ (HP 890C) | high | high | high |
| Static CoF | 0.50 | 0.48 | 0.75 |
| Kinetic CoF | 0.35 | 0.35 | 0.77 |
| Printed Static CoF | 0.67 | 0.56 | 0.76 |
| Printed Kinetic CoF | 0.42 | 0.37 | 0.77 |

As can be seen from the results set forth in TABLE Ill, the use of the slip aid in Examples 1 and 2 enables the production of a glossy sheet having excellent print quality. In addition, the coefficient of friction is substantially reduced in the coatings of Examples 1 and 2, in comparison to the conventional coating of Example 3. As a result, ink jet media having reliable sheet feeding properties are produced. In addition, the media do not feel tacky when handled.

It will be evident that there are additional embodiments and applications which are not disclosed in the detailed description but which clearly fall within the scope of the present invention. The specification is, therefore, intended not to be limiting, and the scope of the invention is to be limited only by the following claims.

What is claimed is:

1. Ink jet media, comprising:
a substrate;
a coating including a binder; and
a low friction substance, in an emulsified form, wherein said substance is selected from the group consisting of waxes, simple organic polymers, silicone polymers and fluoropolymers.

2. The ink jet media according to claim 1, wherein said binder is selected from the group consisting of polyvinylversatate, polyethelene, polyvinyl alcohol, polyvinylpyrrolidone and polyvinylacetate.

3. The ink jet media according to claim 2, wherein said binder comprises between about 5% and about 30%, by weight, of said coating.

4. The ink jet media according to claim 1, wherein said coating includes a slip aid composition.

5. The ink jet media according to claim 4, wherein said slip aid composition is polyterfluoroethylene latex.

6. The ink jet media according to claim 5, wherein said polyterfluoroethylene latex comprises between about 0.5% and about 15%, by weight, of said coating.

7. The ink jet media according to claim 4, wherein said coating includes a performance additive.

8. The ink jet media according to claim 7, wherein said performance additive is selected from the group consisting of diamine ethylene oxide, diamine propylene oxide, glycol, organic acid and silicon ether.

9. The ink jet media according to claim 8, wherein said performance additive comprises between about 0.1% and about 5%, by weight, of said coating.

10. The ink jet media according to claim 1, wherein said coating includes a pigment.

11. The ink jet media according to claim 10, wherein said coating is selected from the group consisting of alumina and silica.

12. A method of preparing ink jet media, comprising the steps of:
providing a substrate;
providing a coating including a binder;
selecting a low friction substance, in an emulsified form, from the group consisting of waxes, simple organic polymers, silicone polymers and fluoropolymers;
mixing together said binder and the selected low friction substance; and
applying the mixture to said substrate.

13. The method according to claim 12, wherein the binder providing step includes selecting from the group consisting of polyvinylversatate, polyethelene, polyvinyl alcohol, polyvinylpyrrolidone and polyvinylacetate.

14. The method according to claim 12, wherein the mixing step includes adding sufficient binder to comprise between about 5% and about 30%, by weight, of said mixture.

15. The method according to claim 12, further including providing a performance additive.

16. The method according to claim 15, wherein said performance additive providing step includes providing polyterfluoroethylene latex.

17. The method according to claim 16, wherein said polyterfluoroethylene latex providing step includes providing between about 0.5% and about 15%, by weight, of said polyterfluoroethylene latex.

18. The method according to claim 15, wherein said performance additive providing step includes providing a surfactant.

19. The method according to claim 15, wherein said performance additive providing step includes selecting said additive from the group consisting of diamine ethylene oxide, diamine propylene oxide, glycol, organic acid and silicon ether.

20. The method according to claim 19, wherein said performance additive providing step includes providing between about 0.1% and about 5%, by weight, of said additive.

21. The method according to claim 12, wherein said coating providing step includes providing a slip aid composition.

22. The method according to claim 21, wherein said providing a slip aid composition step includes providing polyterfluoroethylene latex.

23. The method according to claim 22, wherein said polyterfluoroethylene latex providing step includes providing a sufficient amount of polyterfluoroethylene latex to comprise between about 0.5% and about 15%, by weight, of said coating.

24. The method according to claim 12, wherein said applying step includes applying said mixture to one side of said substrate.

25. The method according to claim 12, wherein said applying step includes applying said mixture to two sides of said substrate.
